(19) United States
(12) Patent Application Publication
(10) Pub. No.: US 2007/0105532 A1
(43) Pub. Date: May 10, 2007

(54) Method and device for pre-saving personal data for a subscriber to a telecommunications network

(75) Inventors: Christophe Martin, Ceyreste (FR); Stephane Schirar, La Bouilladisse (FR)

Correspondence Address: BUCHANAN, INGERSOLL & ROONEY PC, POST OFFICE BOX 1404, ALEXANDRIA, VA, 22313-1404, US

(73) Assignee: GEMPLUS, GEMENOS (FR)

(21) Appl. No.: 10/583,373

(22) PCT Filed: Dec. 15, 2004
(86) PCT No.: PCT/EP04/53518

§ 371 Date: Jun. 19, 2006

(30) Foreign Application Priority Data
Dec. 19, 2003 (FR) 03/51132

(51) Int. Cl. H04L 12/58

(52) U.S. Cl. 455/412.1; 455/558

(57) ABSTRACT

In a method for saving personal data for a subscriber to a wireless communications network, the data is being memorized in a mobile communication station and saved in a network server by means of a first communication channel and in a first saving mode. A determination is made whether the mobile device may establish a second communication channel and/or has an other mode of saving. If so, communication is opened on the second channel and/or according to the other mode, and the data is saved by means of the second communication channel and/or the other mode.

The invention relates to the field of wireless communication networks and, more specifically, to a method of backing up a personal information file, such as a phone book saved in the mobile devices that use these networks or the associated subscriber identity module cards.

In such a network, such as a GSM network (acronym meaning Global System for Mobile Communication), subscribers have a SIM or (U)SIM card (acronyms meaning (Universal) Subscriber Identity Module). This SIM card is personalised so as to allow the subscriber to have access to various applications and/or services. It also contains personal information, such as files of phone books, diaries, etc.

Operators currently allow their subscribers to back up this personal information onto a server by means of SMS messages (acronym meaning Short Message Service).

Most technical solutions rely on a mechanism for synchronising data memorised in the card and/or mobile with the data memorised in a backup database of the server. In this mechanism, only the modified data are transferred with a view to optimising the use of SMS due to the cost involved.

The backup can be started automatically or manually at the request of the user.

When a large volume of data is involved, remote backup onto a server has the disadvantage of having a relatively high cost and taking too much time when performed in a continuous mode.

The amount of time required for backing up a phone book containing 255 telephone numbers with names associated via SMS messages is estimated at around 5 minutes.

On the other hand, not all mobiles have the same functions that would make it possible to implement a unique backup solution that is easy to roll-out and easy to use.

One aim of this invention is to find a mechanism for backing up the personal data of a subscriber to a wireless communication network, the data being memorised in a mobile communication station and backed up in a network server, using a first communication channel and/or according to a first backup mode.

It is characterised in that it comprises at least the following steps, according to which:
it is determined whether the mobile has a function that allows it to establish at least one second communication channel and/or another backup mode and, if so,
communication is opened on this second channel and/or according to this other mode, and the data are backed up via the second communication channel and/or this other mode.

This method, implemented with the help, mainly, of a specific application installed in the SIM card makes it possible to perform backups using the best adapted channel, when it exists. This automatic functioning is useful considering the diversity of the functions supported by the mobile devices available on the market. Not all devices support another communication channel and, in the case of several channels and/or modes being possible, the invention ensures that the user does not need to worry about the configuration required for optimum backups according to its own pre-recorded or pre-selected criteria.

On the other hand, in the case of a less-advanced mobile that does not offer another channel or when a large batch of data needs to be backed up over a given channel that is not very practical in terms of costs and the delay caused, an alternative backup mode can be implemented or proposed to the subscriber (deferred mode, saving mode, etc.)

According to other characteristics of the method:
the mobile function used to establish at least a second channel is BIP;
the method comprises a prior step 11 according to which it detects that the volume of the data to be backed up is larger than a predetermined volume, and the second channel 9 and/or another better adapted mode is selected.

In this regard, other backup arrangements, modes or options can be proposed to the subscriber or implemented automatically, mainly with a view to reducing the waiting time and/or the cost. In the automatic case, the method can implement options, default criteria and selectable criteria, as well tests relating to its options or criteria.
The predetermined volume threshold is equal to 200 Kbytes, and the waiting time threshold is equal to 2 minutes;
The second channel is chosen from among CSD and GPRS;
The first channel is of the type that uses SMS messages;
The method comprises a prior assessment step, in which it is determined whether the cost of the data to be backed up is higher than a predetermined threshold, and the backup is performed according to an adapted channel and/or backup mode.

The invention further relates to a portable device comprising an application for backing up the personal data of a subscriber to a wireless communication network server, using a first communication channel and a first backup mode.

It is characterised in that the application can implement the following steps, which consist of:
determining whether the device has a function and/or another backup mode that allows it to establish at least a second communication channel and/or another backup mode, and if so,
opening the communication on this second channel and/or this other mode, and proceeding to back up the data via this second communication channel and/or this other mode.

According to one characteristic, the portable device consists of a subscriber identity module card. The card is designed to operate with regard to a mobile communication device.

The device according to the invention includes all portable wireless communication devices (mobile), such as PDAs, personal assistants with a wireless communication function and work with or without a chip card, as well as cards with a SIM or U(SIM) chip.

Further characteristics and advantages of the invention will appear from reading the following description of specific embodiments of the invention, said description being provided with the appended drawings, in which:

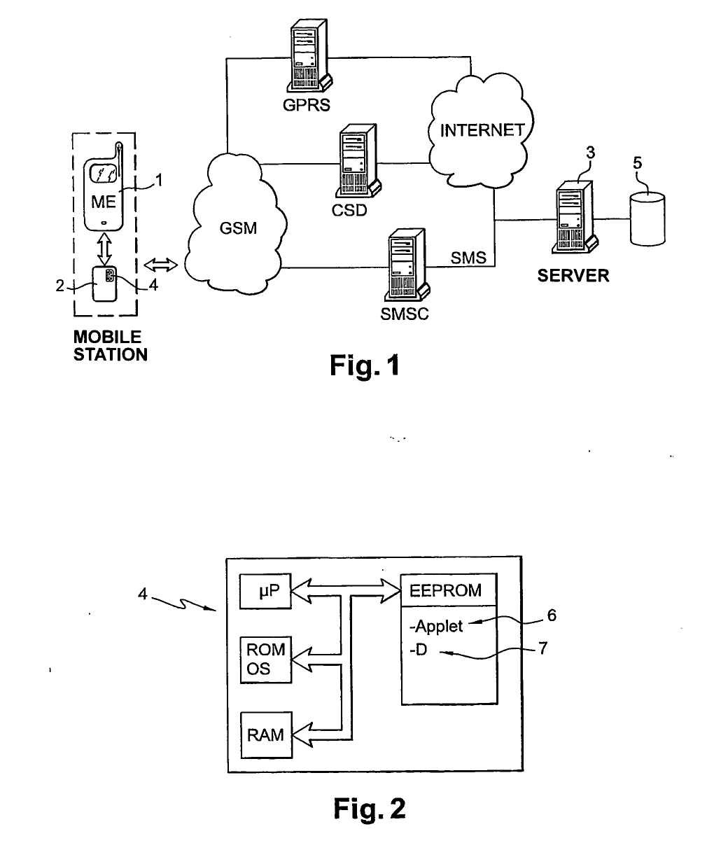

FIG. 1 is a diagram showing the network architecture of the invention,

FIG. 2 is a diagram showing a chip of the SIM card,

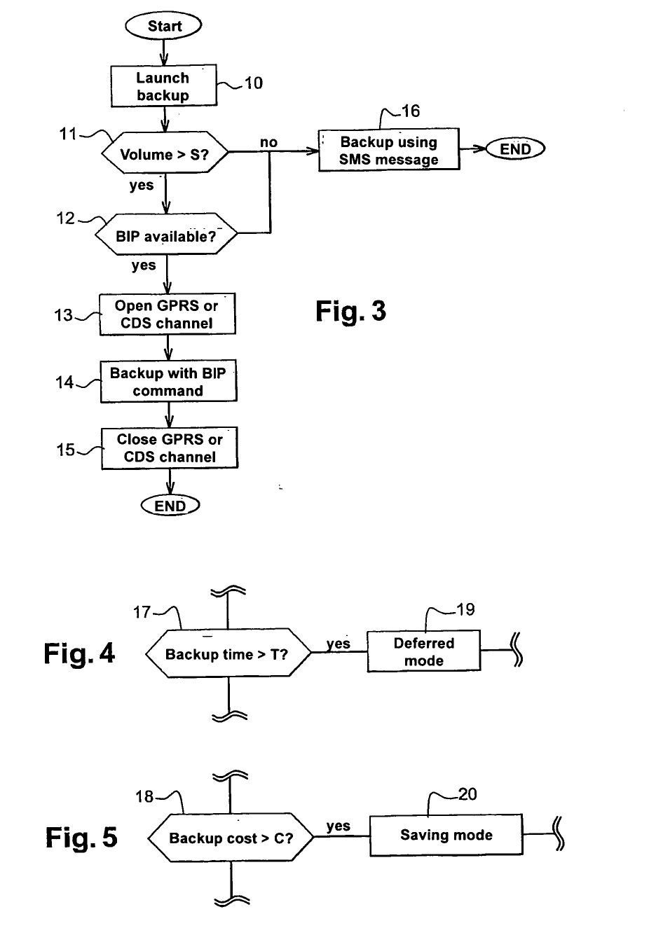

FIG. 3 is a diagram showing the steps in a backup program according to the method of the invention,

FIGS. 4 and 5 show additional or alternative tests and modes of the backup program in FIG. 3.

In the example, a wireless communication architecture is used for a GSM network, comprising mobile radiotelephone stations, comprising mobiles ME 1 of subscribers and equipped with SIM cards 2 and a remote server 3 which can be accessed by so-called SMS messages, via GPRS or CSD channels, which are acronyms meaning General Packet Radio Service and Circuit Switched Data respectively. In fact, multiple networks can be used with different characteristics. They can also include network types such as UMTS or WLAN (acronyms which respectively mean Universal Mobile Telecommunications System and Wireless Local Area Network), which can carry simple or sophisticated personal data of the subscriber, including multimedia such as MMS or streaming audio and video.

The mobiles 1 can include other communication devices such as PDAs, personal assistants equipped with a wireless communication interface.

The personal data 7 can be saved previously in the mobile device 1 and/or in the chip 4 of the card. In the example, the data are initially in the chip.

The server 3 contains a communication interface for receiving and sending messages with the mobile stations, a processing unit, a “server” backup application of a known type and a database 5 for backing up the personal data of the subscribers.

The electronic chip 11 of the subscriber identity module card comprises, in a known fashion, a processor connected via a data and control bus to a ROM application memory on the one hand, which mainly contains an operating system for the card and specific algorithms, and to a programmable memory and a random access memory (RAM) on the other hand.

The programmable memory, mainly such as EEPROM, mainly includes the subscriber's data or data relating to the latter's subscription with its associated encoding key (IMSI, Ki), which can authorise a communication service and specific applications.

According to a characteristic of the invention, the card includes an application 6, called an applet, which is saved in its programmable memory and can launch a backup of the data in an optimised fashion according to the available and/or accessible channels and/or according to specific backup modes.

The application can, for example, be of the SIM toolkit type, which means that it uses sets of commands that conform to the GSM 11.14 standard, allowing the card to be “pro-active” in the sense that it takes the initiative mainly for managing the mobile.

While the card's processor is running the applet, the card takes over all exchanges with the mobile.

This backup program can, in a known fashion, request the mobile to transmit at least one first subset of data from among a batch of data to be backed up to the server for backing up.

The method of the invention is described, initially, in relation to FIG. 3 according to the preferred mode.

A subscriber has a SIM card 2 with a GPRS subscription and an advanced backup application called “applet SIMchronise BIP”. The personal data in the SIM consist of a phone book containing 255 telephone numbers, with a volume of more than 500 Kbytes.

The subscriber inserts the SIM in the mobile 1, which supports the BIP function (an acronym meaning Bearer Independent Protocol). The “BIP” function is an option of the ESTI “GSM 11 14” standard, which describes the “SIM Toolkit” (STK) and defines a series of commands and pro-active situations of the card. According to this protocol, the SIM can use the communication means of the mobile equipment ME, regardless of the communication technology used.

The SIM automatically detects if the mobile supports “BIP” when receiving its status during a preliminary data exchange. It can save this information in an adapted memory.

The subscriber launches 10 the backup of his/her phonebook to a remote server 3 from a menu of the backup application displayed on the screen.

The backup program 6 implements a step of assessing the data to be backed up (this step is implicit or included in the following test) and tests 11 the volume of data to be backed up. The volume assessed is compared with a threshold that is equal to 200 Kbytes.

Since the volume of data to be backed up exceeds the threshold, the backup program connects to another test 12, which consists of determining whether the mobile supports BIP.

In this test, the information received from the mobile when it is switched on is read and saved in a status memory in the card. Since the mobile supports BIP, this means that the backup can be performed via another channel that is more useful given the volume of data to be backed up.

Since this is the case, in the following step 13, the card opens the GPRS channel and then requests the mobile in step 14 to send the data to be backed up via this channel.

The backup is then carried out in GPRS mode with sequential displaying of the number of numbers sent throughout the process, at very high speed.

Upon receiving an acknowledgement of receipt from the server or before receiving it, the SIM card sends a command to close the GPRS channel in step 15, which ends the advanced backup program according to the invention.

Then, the subscriber adds a new contact to his/her phone book and, from the menu of his/her backup application, launches the backup to the server as above.

The application has assessed that the volume of data to be backed up is less than 200 Kbytes (NO branch in the test 11) and therefore connects directly to a step 16 that consists of sending a command to the mobile for the latter to transmit the number to the server via a first channel that supports SMS messages, and does so in continuous mode.

For the definition of the threshold, the backup program which receives, for example an instruction for a maximum waiting time of 1 minute, can comprise a logic that transposes the waiting time threshold into a volume threshold and vice-versa. The program can transpose, according to known values of the bandwidths of the different channels, the time required for transmitting a volume of data according to the predetermined rules that it contains.

According to other characteristics of the invention, the program can also consist of assessing of the best channel to be used according to different criteria and by means of automatic switching to an adapted channel.

It can also consist of informing the subscriber of the best channel, allowing the latter to select the channel to be used from those displayed on the screen.

Criteria such as waiting time, cost, reliability, etc., can be programmed and modified according to the requirements of the subscribers.

An additional or alternative test 11 is shown in FIGS. 4 and 5. The test can consist of meeting criteria such as the time required for the backup 17 (unavailability of the mobile) or possibly the cost of the backup 18 (large data, photos, multimedia, etc.). In this way, the subscriber can choose to back up a considerable amount of data but at the same time reduce the cost and/or the waiting time.

The invention can include other specific backup modes (19, 20), including saving mode, deferring the backup in time and/or space and starting the backup during more advantageous time slots or whenever a specific network coverage is detected.

A deferred mode can be, for example of the asynchronous type, which breaks down the data to be backed up and spaces out the backup. Likewise, it can consist of performing the backup at a specific time or in a specific location (a geographical area, for example, in the case of WLANs). The backup can be performed automatically as soon as the conditions that meet the criteria are fulfilled, the geographical location is detected or specific network coverage is obtained.

These different modes are set off by associated tests included in the backup application. The test thresholds and/or different criteria can be configured by default or by the subscriber.

In order to define the cost of a backup operation, the device can include a cost chart or a calculation rule used by the backup application according to the applicable cost parameters at the time. The reference values and the parameters of these costs can be downloaded by the operator or by a server. The projected cost can also be determined by a prior exchange between the mobile station and the server.

One characteristic of the method of the invention rests in the means or steps that make it possible to perform the backup in different ways, whether via channels and/or according to modes adapted according to the criteria of the subscriber.

The subscriber can be offered a channel and/or a backup mode according to criteria chosen by order of priority, for example in the order of cost, speed, reliability and security; or possibly with thresholds, combinations or reports of imposed criteria and/or modes, such as better cost/reliability ratio, cost/security ratio, etc. SMS may be preferred for reliability, while GPRS may be preferred for speed and cost.

For this reason, the application can include a chart with the properties/advantages of the different modes and channels available, which will be compared with the criteria introduced or selected by the subscriber in order to predefine the optimum manner in which the backup will be performed.

In the case of the mobile not being very advanced, for example because it does not support the BIP function, the operation of the advanced backup application can be transparent for the subscriber, in the sense that the program will always end with backup over SMS. Where appropriate, only certain backup modes can be used and, whenever the subscriber obtains a new mobile that that can operate using different channels, he/she can keep the SIM card that contains his/her personal data and will be able to implement the advanced backup application automatically.

In the opposite case, if the mobile supports several channels such as GPRS and CSD or WLAN, the invention allows advanced, customised backup as mentioned above.

1. Method of backing up the personal data of a subscriber of a wireless communication network, the data being memorised in a mobile communication station and backed up to a network server, across a first communication channel and according to a first backup mode, comprising the following steps:
determining whether the mobile device has a function that allows it to establish at least a second communication channel and/or another backup mode, and if so,
opening communication on said second channel and/or according to said other mode, and the data are backed up via said second communication channel and/or said other mode.

2. Method according to claim 1, wherein the function that makes it possible to establish at least a second communication channel is Bearer Independent Protocol (BIP).

3. Method according to claim 1, comprising a prior step of detecting that the volume of the data to be backed up is larger than a predetermined volume, and selecting the second channel and/or another better adapted mode.

4. Method according to claim 3, wherein the predetermined volume is equal to 200 Kbytes.

5. Method according to claim 1, wherein the second channel is chosen from among CSD, GPRS and WLAN.

6. Method according to claim 1, wherein the first channel is an SMS short message channel.

7. Method according to claim 1, including a prior assessment step, of determining whether the cost of the data to be backed up is higher than a predetermined threshold, and performing the backup according to the best adapted channel and/or backup mode.

8. Method according to claim 1, including a prior assessment step of determining whether the cost of the data to be backed up is higher than a predetermined threshold,
and performing the backup according to an adapted channel and/or backup mode.

9. Portable device comprising an application for backing up personal data of a subscriber of a wireless communication network by means of a first communication channel and according to a first backup mode,
wherein the application can implement the following steps, comprising:
determining whether the device has a function and/or another backup mode that allows it to establish at least a second communication channel and/or another backup mode, and if so,
opening the communication on said second channel and/or said other mode, and proceeding to back up the data via said second communication channel and/or said other mode.

10. Portable device according to claim 9, wherein said device comprises a subscriber identity module card.

11. Method according to claim 2, comprising a prior step of detecting that the volume of the data to be backed up is larger than a predetermined volume, and selecting the second channel and/or another better adapted mode.

12. Method according to claim 2, wherein the second channel is chosen from among CSD, GPRS and WLAN.

13. Method according to claim 3, wherein the second channel is chosen from among CSD, GPRS and WLAN.

14. Method according to claim 4, wherein the second channel is chosen from among CSD, GPRS and WLAN.

15. Method according to claim 2, wherein the first channel is an SMS short message channel.

16. Method according to claim 3, wherein the first channel is an SMS short message channel.

17. Method according to claim 4, wherein the first channel is an SMS short message channel.

18. Method according to claim 5, wherein the first channel is an SMS short message channel.

19. Method according to claim 2, including a prior assessment step, of determining whether the cost of the data to be backed up is higher than a predetermined threshold, and performing the backup according to the best adapted channel and/or backup mode.

20. Method according to claim 3, including a prior assessment step, of determining whether the cost of the data to be backed up is higher than a predetermined threshold, and performing the backup according to the best adapted channel and/or backup mode.
